(19) United States
(12) Patent Application Publication
(10) Pub. No.: US 2006/0190234 A1
(43) Pub. Date: Aug. 24, 2006

(54) Property generating method, verification method and verification apparatus

(76) Inventor: Yasuyo Shimizu, Kawasaki-shi (JP)

Correspondence Address: MORGAN & FINNEGAN, L.L.P., 3 WORLD FINANCIAL CENTER, NEW YORK, NY, 10281-2101, US

(21) Appl. No.: 11/354,474

(22) Filed: Feb. 14, 2006

(30) Foreign Application Priority Data
Feb. 18, 2005 (JP) 2005-043143

(51) Int. Cl. G06F 17/50

(52) U.S. Cl. 703/16; 703/15; 714/724

(57) ABSTRACT

When a property for verifying a logic system is generated, a list of corresponding events is generated from specifications that the logic system should meet, an event of an undefined state in a first property is extracted from the list of events, and a property representing that the extracted event of the undefined state is improbable is generated as a second property that makes up for an event lacking in the first property.

### FIELD OF THE INVENTION

This invention relates to a technique used in generating properties for verifying a logic system, and to a technique for verifying the logic system.

### BACKGROUND OF THE INVENTION

There is increasing market demand for products of higher functionality, and this has been accompanied by increasing scale of logic systems that incorporate LSI chips. For this reason, an enormous amount of time is needed for verification of logic systems. Further, a product must be introduced on the market when it is desired by the consumer, and development time for logic systems, especially LSI chips, is shortening. This makes it necessary to improve the verification efficiency of logic systems.

In verification of a logic system that includes an LSI chip, a static verification method has come to be used in conjunction with a dynamic simulation method employed heretofore. Static verification is classified into two types, namely property check and equivalency check. A property check performs verification by mathematically evaluating the agreement between the result of expressing a specification, which is referred to as a property, by a formula and a DUT (Design Under Test) of the object of verification. With the property check, therefore, it is possible to complete verification in a shorter period of time in comparison with dynamic simulation. For example, the specification of Japanese Patent Application Laid-Open No. 11-85828 describes a verification method that improves the coverage rate of a dynamic simulation using format verification based upon DUT.

Although it is said that static verification having such properties makes possible exhaustive verification, in actuality verification only of the portion that describes the property is performed. In addition, a confirmation method as to whether exhaustive verification has been achieved has not been established with the exception of implementation of review manually.

Thus, there is no method of objectively determining whether exhaustive verification has been achieved by static verification. As a result, there is the danger than a product possessing unsatisfactory accuracy will be introduced on the market without it being noticed that a portion that has not undergone verification exists.

Further, basically it is possible to reduce verification labor by dividing functions into functions verified by dynamic simulation and functions verified by static verification. In actuality, however, static verification is used for supplementary purposes in addition to conventional dynamic simulation and verification labor continues to increase as a consequence.

### SUMMARY OF THE INVENTION

An object of the present invention is to solve the problems mentioned above.

Another object of the present invention is to make it possible to judge the coverage rate in static verification objectively.

Another object of the present invention is to make exhaustive verification possible.

Another object of the present invention is to reduce verification labor.

Another object of the present invention is to improve the quality of a property.

In accordance with an aspect of the present invention, the foregoing objects are attained by providing a property generating method of generating a property for verifying a logic system, comprising:
a list generating step of generating a list of corresponding events from specifications that the logic system should meet; and
a property generating step of generating a second property that makes up for an event lacking in a first property.

Further, in accordance with an aspect of the present invention, there is provided a verification method of verifying a logic system using a property, comprising:
a list generating step of generating a list of corresponding events from specifications that the logic system should meet;
a property generating step of generating a second property that makes up for an event lacking in a first property; and
a verification implementing step of implementing static verification of the logic system using the second property.

Further, in accordance with an aspect of the present invention, there is provided a verification apparatus for verifying a logic system using a property, comprising:
property generating means for generating a list of corresponding events from specifications that the logic system should meet, and generating a second property that makes up for an event lacking in a first property; and
verification implementing means for implementing static verification of the logic system using the second property.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram illustrating a procedure for generating improbable properties used in static verification in an embodiment of the present invention;

FIG. 2 is a diagram illustrating an example of specifications and a list of all events shown in FIG. 1;

FIG. 3 is a flowchart illustrating processing by an extraction module in this embodiment;

FIG. 4 is a diagram illustrating user-defined properties, user-undefined states and an all-event list after comparison;

FIG. 5 is a flowchart illustrating processing by an improbable property conversion module;

FIG. 6 is a diagram illustrating an example of an improbable property to the effect that a user-undefined state is always improbable;

FIG. 7 is a diagram illustrating a procedure for implementing static verification using improbable properties and generating an additional property; and

FIG. 8 is a flowchart illustrating processing for implementing static verification and adding on a defect of user-defined properties.

### DETAILED DESCRIPTION OF THE PREFERRED EMBODIMENT

A preferred embodiment of the present invention will now be described in detail with reference to the drawings.

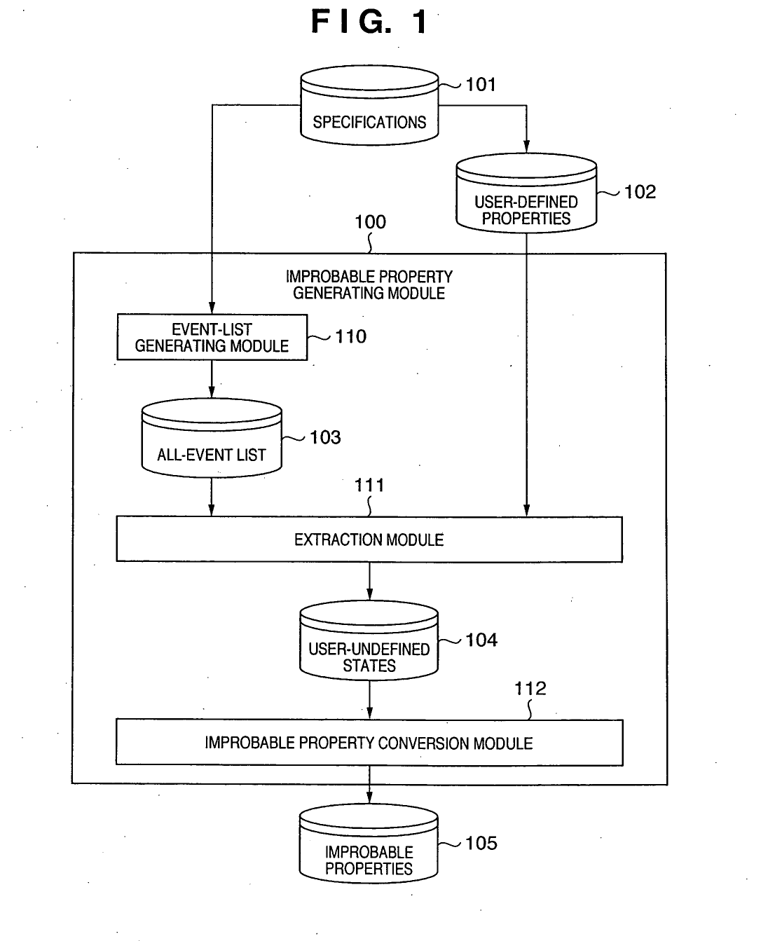

FIG. 1 is a diagram illustrating a procedure for generating an improbable property used in static verification in an embodiment of the present invention. In FIG. 1, specifications 101 constitute data in which the specifications of a logic system are described. The specifications 101 do not depend upon a form and it will suffice if they are written in such a manner that it is possible to extract the input signals of a logic system, the internal signals thereof and values that can be taken on by these signals. The specifications 101 may be described in natural language or in any other language or form.

Further, in this embodiment, it is assumed in all cases that the specifications 101 are correct and that a later-described user-defined property, all-event list and DUT (Design Under Test) of the object to be verified are all created based upon the data of the specifications 101.

User-defined properties 102 are described by the user based upon the specifications 101, and it is assumed that the described content is without error. However, it is assumed that there is a possibility that an unverified portion exists. Further, the user-defined properties 102 may be described manually or automatically from a test-item list or the like.

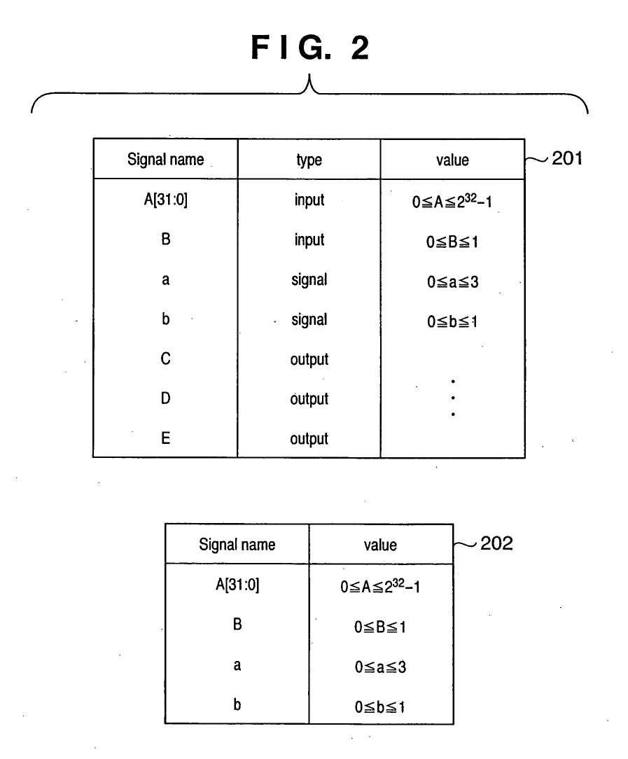

Based upon the specifications 101, an event-list generating module 110 extracts values that can be taken on by input signals and internal signals of a logic system to undergo verification, and generates a list of all events that can be taken on by the specifications 101. The function of the event-list generating module 110 will be described later in further detail with reference to FIG. 2.

This embodiment is not dependent upon the algorithm that generates the event list, and any algorithm may be used. For example, all values that can be taken on by necessary signals may be extracted from the specifications 101 automatically, and an event that is lacking after automatic extraction may be appended by the user.

An all-event list 103 is generated by the event-list generating module 110 based upon the specifications 101. All events that can be taken on by the specifications 101 are described in the all-event list 103. It will suffice if the all-event list 103 has a form that can be interpreted by an extraction module, which is described below, and any such form may be used.

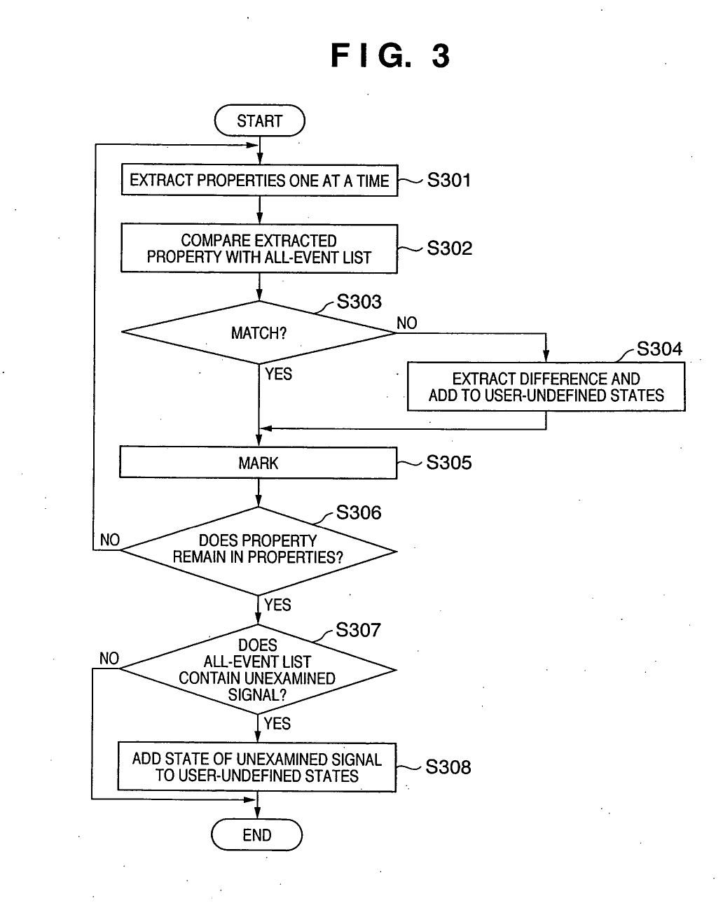

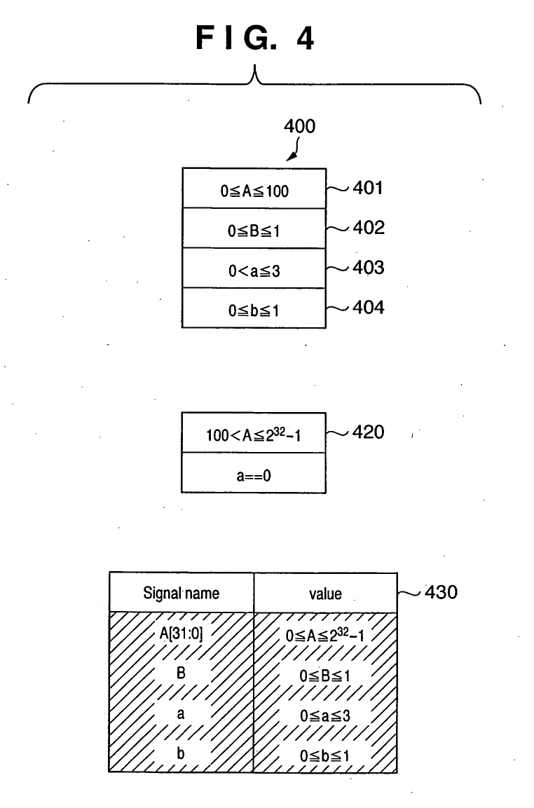

An extraction module 111 extracts an event of a user-undefined state from the user-defined properties 102 and all-event list 103. The function of the extraction module 111 will be described later in further detail with reference to FIGS. 3 and 4.

Events in a user-undefined state 104 are described in the all-event list 103 but not described in the user-defined properties 102. This event is extracted by the extraction module 111. The events in the user-undefined state are a complementary set that makes up for insufficiencies in the user-defined properties 102.

An improbable property conversion module 112 converts the event in the user-undefined state 104 to an improbable property that is always assumed to be improbable. The function of the improbable property conversion module 112 and the reason why this is necessary will be described later in greater detail.

Improbable properties 105 are properties obtained as a result of the conversion performed by the improbable property conversion module 112. By implementing static verification or the like using the improbable properties 105, it is possible to add on a lacking property to the user-defined properties 102.

An improbable property generating module 100 generates the improbable properties 105 based upon the specifications 101 and user-defined properties 102 as described above.

Next, a method of generating the all-event list 103 in the above-described event-list generating module 110 based upon the specifications 101 will be described.

FIG. 2 is a diagram illustrating an example of the specifications 101 and all-event list 103 shown in FIG. 1. Specifications 201 shown in FIG. 2 illustrate one example of the specifications 101 described above. Here signal name, type and value that can be taken on thereby are described in tabular form. The specifications that can be utilized in the present invention are not limited to the tabular form.

An all-event list 202 is one that has been extracted based upon the specifications 201 and illustrates an example of the all-event list 103. In this example, the all-event list 202 describes the input signals and internal signals of the specifications 201 and the ranges of values that can be taken on by these signals.

The all-event list 202 may be extracted from the specifications 201 automatically or manually by the user. Further, the all-event list 202 may be extracted using any method that is capable of extracting the events of all states from the specifications 101. Furthermore, the form of the all-event list 202 in the present invention is not limited to this form.

Described next will be a method of extracting the event in a user-undefined state 104 in the extraction module 111 based upon the all-event list 103 and user-defined properties 102.

FIG. 3 is a flowchart illustrating processing executed by the extraction module 111 in this embodiment. First, at step S301, properties are extracted from the user-defined properties 102 one at a time. Next, at step S302, the property extracted at step S301 is compared with the all-event list 103 at step S302 and it is determined whether there is a match at step S303. Control proceeds to step S305 if there is a match. If there is no match, then control proceeds to step S304. Here the difference with regard to the property that did not match is extracted and this is added to the events in user-undefined states 104. The properties that matched with the content of the all-event list 103 and those for which the difference was extracted are marked at step S305.

Next, it is determined at step S306 whether properties remain in the user-defined properties 102. If a property remains, control returns to step S301 and the above-described comparison processing is repeated. Control proceeds to step S307 when properties no longer remain in the user-defined properties 102.

Whether the all-event list 103 contains an unexamined signal is determined at step S307. If there is no unexamined signal, processing is terminated. If there is an unexamined signal, however, control proceeds to step S308. Here the state of the unexamined signal is added to the list of user-undefined states 104.

Reference will be had to FIG. 4 to describe the details of processing for adding the state of an unexamined signal to user-undefined states.

FIG. 4 is a diagram illustrating user-defined properties, user-undefined states and an all-event list after comparison (after marking at step S305). In FIG. 4, user-defined properties 400 have been generated from the specifications 201 shown in FIG. 2. In this example, it is assumed that four properties 401 to 404 have been described. Reference numeral 420 denotes a list of user-undefined states. Events of undefined states not described in the user-defined properties 400 are added to the list of user-undefined states. Reference numeral 430 denotes a list of all events after the comparison.

As mentioned above, properties extracted from the user-defined properties 400 at step S301 have been generated by the user from the specifications 201. Although there is no error in the described content, there is the danger of insufficiency. In this embodiment, the user-defined properties 400 are such that the ranges of signals are described by a table. However, the form of user-defined properties in the present invention is not limited to this form.

Next, at step S302, the property extracted at step S301 is compared with the all-event list 202 to determine whether there is a match. For example, in a case where property 401 described with regard to signal A has been extracted from the user-defined properties 400, this is compared with the signal A portion of the all-event list 202.

It is determined at step S303 whether there is a match, i.e., whether the content of the user-defined properties 400 satisfies the content of the all-event list 202. If there is a match, then the user-defined properties 400 cover the entire all-event list 202 and there is no property insufficiency. On the other hand, if there is no match, then a difference develops between the user-defined properties 400 and the all-event list 202 and an insufficiency exists in the user-defined properties 400.

Further, the user-defined properties 400 have been described based upon the specifications 201 and properties that exceed the ranges of the specifications 201 have not been described. Accordingly, it is correct to assume that there is no signal that exists in the user-defined properties 400 but not in the all-event list 202.

If it is determined at step S303 that there is no match, then the difference between the user-defined property 400 and the all-event list 202 is extracted at step S304. For example, the property 401 and the all-event list 202 are compared. With special regard to the description of signal A, it is described in property 401 that the range of values that signal A can take on is 0 to 100. In the all-event list 202, however, signal A can take on values ranging from 0 to 2³²−1. In other words, when the difference is extracted, it is understood that signal A is larger than 100 and values up to 2³²−1 have not been described in the user-defined properties 400. Accordingly, this result is added to the user-undefined states 420. Similarly, with regard to property 403, a state in which a signal a is 0 is extracted and added to the user-undefined states 420. It should be noted that the form of the user-undefined states in the present invention is not limited to the form illustrated in FIG. 4.

Signals for which judgment has been completed in the all-event list 202 are marked at step S305. In the example shown in FIG. 4, the user-defined properties 400 cover all of the signals A, B, a and b described in the all-event list 202 and therefore all are marked as shown in the converted all-event list 430. The fact that the signals have been marked is indicated by the hatching in FIG. 4.

In a case where the number of signals described in the user-defined properties 400 fall short of the number of signals in the all-event list 202, locations that are not marked will exist in the all-event list 430 after the comparison. It will be understood that unmarked signals are signals that have not been extracted. That is, in order to make it known that a signal has not been extracted, the signal is marked.

Whether a property remains in the user-defined properties 400 is determined at step S306. If no properties remain, then control proceeds to step S306 as is. If properties remain, however, the processing of steps S301 to S306 is repeated until properties no longer remain.

Whether the converted all-event list 403 contains an unverified signal is determined at step S307. In other words, it is determined whether there is no unmarked signal. For example, as a result of comparing the user-defined properties 400 and the all-event list 202, a signal name present in the all-event list 202 but not present in the user-defined properties 400 does not exist. All signals, therefore, are marked, as in the compared all-event list 430. This means that unexamined signals do not exist in the all-event list 202. In this case, it is determined that examination of all signals has been completed and all processing may be exited.

On the other hand, if a signal not marked is in the converted all-event list 430, then an unexamined signal exists and control therefore proceeds to the next processing step.

If an unexamined signal is determined to exist at step S307, the state described in the all-event list 202 is added to the list 420 of user-undefined states as is as the event of the unexamined signal at step S308. As a result, all events of the specification 101 can be added to the list 420 of user-undefined states.

Although the complementary set that makes up for insufficiencies in the user-defined properties in the all-event list is found by comparing the all-event list and user-defined properties, any method may be used as the method of obtaining the complementary set.

Further, the comparison processing, extraction processing and marking according to the present invention are not limited to the above description and any methods may be adopted.

Described next will be processing for converting the events in the user-undefined states 104 to the improbable properties 105 in the improbable property conversion module 112.

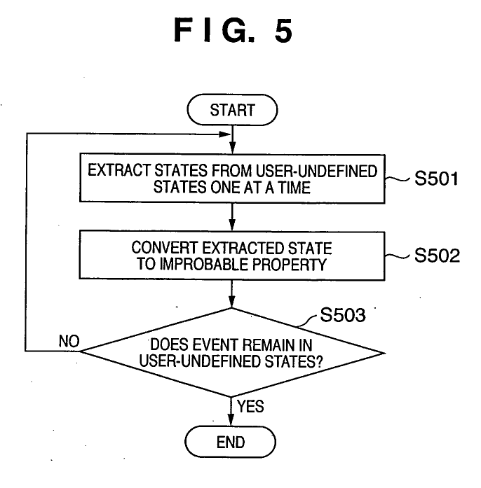

FIG. 5 is a flowchart illustrating processing executed by the improbable property conversion module 112. First, events are extracted from the user-undefined states 104 one at a time at step S501, and each event that has been extracted at step S501 is converted to an improbable property at step S502. Next, at step S503, it is determined whether at least one event remains in the user-undefined states 104. If at least one event remains in the user-undefined states 104, control returns to step S501 and the above-described processing is repeated. If a state does not remain, then processing is exited.

The reason for generating the improbable properties 105 in this embodiment will now be described. In a case where DUT is verified using the user-defined properties 102, it cannot be construed that exhaustive verification is possible if all of the content described in the specification 101 is not being expressed as the user-defined properties 102.

Accordingly, on the assumption that the user-defined properties 102 express all of the specifications 101 and that states not described are not ranges of values taken on by the specifications 101, properties to the effect that “a state not described in the user-defined properties cannot occur” are generated. These are the improbable properties 105. If it so happens that “a state which should not occur can occur” is determined when verification is performed using the improbable properties 105, the fact that an improbable property is generated makes it possible to ascertain that the property is not lacking in the user-defined properties 102.

For example, if such an operation is incorporated as a tool, an error display to the effect “The state of a property that has not been described has occurred in the DUT, but is this property correct?” is output and a property insufficiency or bug in the DUT is discovered.

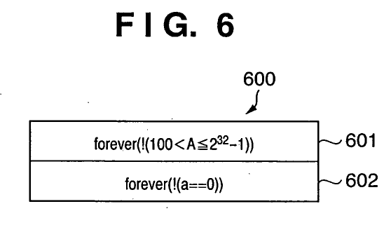

A method of generating the improbable properties 105 will be described using the user-undefined states 420 shown in FIG. 4 and FIG. 6. An example of generating a property “a user-undefined state is always improbable” will be described as a method of generating the improbable properties 105. However, as long as an improbable operation is generated, the method is not limited.

FIG. 6 is a diagram illustrating an example of an improbable property to the effect that a user-undefined state 420 is always improbable. In FIG. 6, reference numeral 600 denotes properties for proving that the user-undefined state 420 is improbable. Here properties 601, 602 are such that “forever” and “!” are have been attached to user-undefined states 420. The meanings of these are as follows:
“forever”==“forever”
“I!”==“denial (will not occur)”

That is, the property 601 signifies “the fact that signal A will take on a value greater than 100 and less than 2³²−1 can forever not occur”, and the property 602 signifies “signal a can forever not become zero”.

As a result, a property to the effect that “a state described in the user-undefined states will forever not occur” is added on. When static verification is performed, it is possible to verify all events that can be taken on in the specifications 101 by using the user-defined properties 102 and improbable properties 105.

Described next will be an example in which static verification is performed using the added-on improbable properties 105 and a defect of the user-defined properties 102 is pointed out.

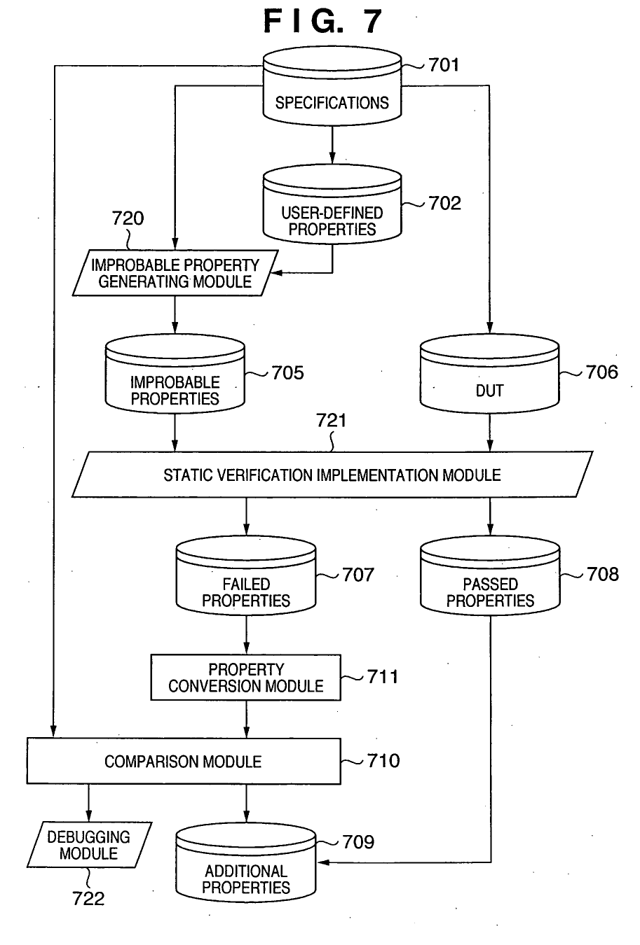

FIG. 7 is a diagram illustrating a procedure for implementing static verification using improbable properties and generating an additional property. Specifications 701 and user-defined properties 702 shown in FIG. 7 correspond to the specifications 101 and user-defined properties 102, respectively, illustrated in FIG. 1. Further, an improbable property generating module 720 and improbable properties 705 correspond to the improbable property generating module 100 and improbable properties 105, respectively, illustrated in FIG. 1.

A DUT 706 illustrated in FIG. 7 is design data of a logic system described by hardware description language such as Verilog or VHDL (VHSIC Hardware Description Language) generated based upon the specifications 701. This data may be generated automatically or created manually from the specifications 701.

A static verification implementation module 721 implements static verification using the improbable properties 705 and DUT 706. The static verification implementation module 721 may be implemented using any tool or any other method.

As a result of verification by the static verification implementation module 721, a log of failed properties 707 and a log of passed properties 708 are obtained. Properties among the improbable properties 705 that have failed the static verification are recorded in the failed properties 707. A state in which an improbable property 705 has failed signifies the fact that at least one event in a user-undefined state 104 shown in FIG. 1 exists in the DUT 706. That is, regardless of a state that has not been described by the user, this state can occur in the DUT 706 and hence there is the possibility that there is a defect in the user-defined properties 702 or a bug in the DUT 706.

On the other hand, properties among the improbable properties 705 that have passed the static verification are recorded in the passed properties 708. A state in which an improbable property 705 has passed signifies the fact that an event in a user-undefined state 104 shown in FIG. 1 does not exist in the DUT 706. That is, the state was originally not described in the specification and is intrinsically a state that cannot occur. Accordingly, the properties recorded in the passed properties 708 have no defects in terms of the user-defined properties 702. However, this state is recorded in additional properties 709 as is in the form of an improbable property in order to confirm that the state cannot occur.

Next, a property conversion module 711 converts the failed properties 707 from improbable to probable properties. The reason for this is that with the improbable properties 705 in the form “a user-undefined state cannot occur”, the properties and DUT 706 will be in contradiction and therefore it is necessary to perform a conversion to the property “a user-undefined state occurs”.

A comparison module 710 compares properties that have failed and been converted from improbable to probable properties with the specifications 701 and determines whether there was a defect in the user-defined properties 702 or whether failure was the result of a bug in the DUT 706. Any method may be used to perform this comparison.

The property conversion module 711 records properties found as being defective in the user-defined properties 702 (properties that have been converted from improbable to probable properties) in additional properties 709. It should be noted that the order in which the conversion by the property conversion module 711 and the comparison by the comparison module 710 are performed is not limited to the order set forth above. That is, it may be so arranged that after the comparison is performed by the comparison module 710, a property found as being defective in the user-defined properties 702 is converted from improbable to probable by the property conversion module 711 and is thenceforth recorded in the additional properties 709.

A debugging module 722 debugs a property determined to be a bug in the DUT 706 as a result of the comparison of specifications 701 and failed properties 707 by the comparison module 710. Here a bug signifies that a contradiction has occurred between the specifications 701 and the DUT 706. Any debugging method may be employed.

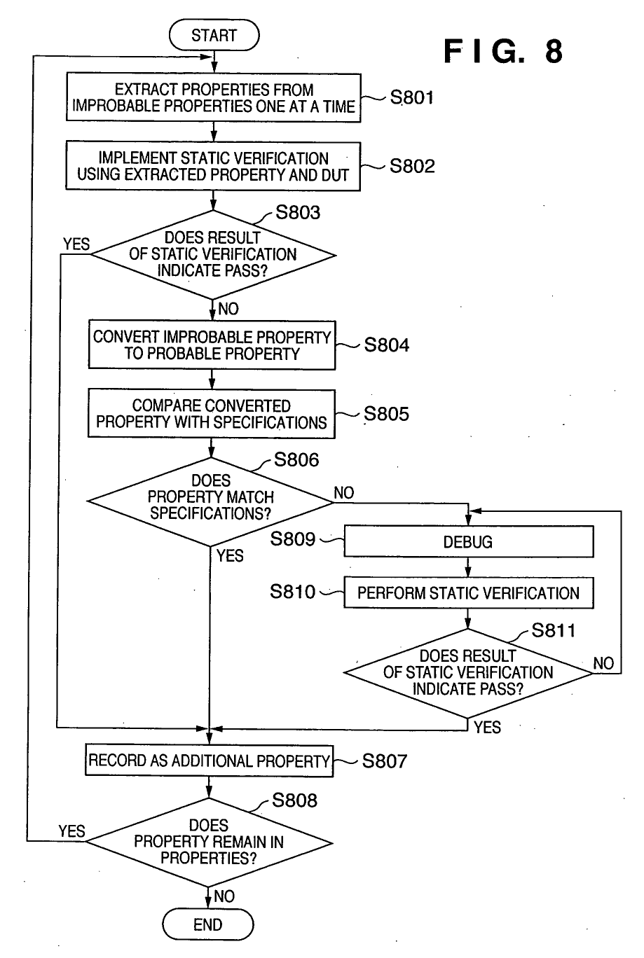

FIG. 8 is a flowchart illustrating processing for implementing static verification and adding on a defect of user-defined properties. That is, FIG. 8 is a flowchart illustrating the flow of processing in a case where improbable properties 707 are extracted one at a time; static verification is carried out by the static verification implementation module 721 and comparison by the comparison module 710.

First, properties are extracted from the improbable properties 705 one at a time at step S801 and static verification is performed at step S802 using the property extracted at step S801 and the DUT 706. The processing of step S802 corresponds to the static verification by the static verification implementation module 721.

Next, the result of the static verification performed at step S802 is evaluated at step S803. Control proceeds to step S807 if the static verification passes and to step S804 if it fails. A property left as an improbable property that has passed as a result of the static verification at step S803 is recorded as an additional property 709 at step S807.

The improbable property 705 is converted to a probable property at step S804. An example of the conversion will be illustrated using FIG. 6. If it is reported at step S803 that the property 601 has failed the static verification, then the expression
“forever(!(100<A≦2³²−1))”
will not hold. In other words, this means that
“100<A≦2³²−1” . . . P1
has occurred in the DUT 706.

Accordingly, the property P1 should be recorded in the additional properties 709. For this reason the property that was converted to an improbable property is converted to a form in which it is probable. Although the conversion method is made one that simply extracts “forever” and “!”, the conversion method is not limited to this method. The processing of step S804 corresponds to the property conversion by the property conversion module 711.

Next, the property P1 obtained by the conversion at step S804 is compared with the specifications 701 at step S805. The reason for this is that there is a possibility not only of simple omission of properties as a cause of failure of the static verification at step S803 but also of the occurrence of an event, which rightfully must not occur, owing to bugs in the DUT 706. It is necessary to make a comparison with the specifications 701 in order to avoid overlooking bugs in the DUT 706. Any comparison method may be used. The processing of step S805 corresponds to the comparison performed by the comparison module 710.

It is determined at step S806 whether the result of the comparison at step S805 is a match between the specifications 701 and the property. Control proceeds to step S807 if there is a match and to step S809 if there is no match.

The property obtained by the conversion at step S804 is recorded as an additional property 709 at step S807.

Further, as a result of the comparison performed at step S805, it is known that the property generated at step S804 does not match the specifications 701. Accordingly, the DUT 706 is debugged based upon the specifications 701 and property information. The processing of step S809 corresponds to debugging by the debugging module 722.

Next, in order to confirm that debugging was performed correctly at step S809, static verification is performed at step S810 using the debugged DUT 706 and property generated at step S804. At this time the property used in static verification may be construed to be correct since the property has already been compared with the specifications 701 at step S805.

The result obtained at step S810 is evaluated at step S811. If the result of static verification at step S810 is that the property has passed, control proceeds to step S807. Here the property used (the property obtained by the conversion at step S804) is recorded as the additional property 709. If the property failed, then control returns to step S809 and processing from step S809 to step S811 is repeated using the same property until the DUT 706 is debugged and the property passes the static verification.

It should be noted that if the result of the static verification at step S803 is that the property passed, then the property left as an improbable property is recorded as the additional property 709 at step S807. On the other hand, if it is found at step S806 that the property matches the specifications 701, then the property obtained by the conversion at step S804 is recorded at the additional property 709. Further, if the DUT 706 is discovered at step S806 and it is now immediately after the correction of the DUT 706, then the property obtained by the conversion at step S804 is recorded as the additional property 709.

For example, if the property passed at step S803, then property P1 is added on. In other cases the property 601 is added on.

Next, at step S808, it is determined whether a property remains in the improbable properties 705. Control proceeds to step S801 if a property remains and processing ends if a property does not remain.

Thus, in accordance with this embodiment, as described above, it is possible to judge coverage rate in static verification objectively by generating an all-event list and improbable properties. Exhaustive verification in static verification, which is difficult conventionally, becomes possible.

Further, since coverage rate of static verification can be judged objectively, the time needed for review conventionally is dispensed with and verification labor can be reduced. In addition, owing to the fact the exhaustive verification in static verification becomes possible, it is possible to divide functions into to be verified by static verification and functions to be verified by dynamic simulation. This makes it possible to reduce verification labor.

It should be noted that each module mentioned above may be implemented by an ordinary computer of by special-purpose equipment.

The present invention may be applied to a system constituted by a plurality of devices (e.g., a host computer, interface, reader, printer, etc.) or to an apparatus comprising a single device (e.g., a copier or facsimile machine, etc.).

Furthermore, it goes without saying that the object of the invention is attained also by supplying a recording medium storing the program codes of the software for implementing the functions of the foregoing embodiment to a system or an apparatus, reading the program codes with a computer (e.g., a CPU or MPU) of the system or apparatus from the recording medium, and then executing the program codes.

In this case, the program codes per se read from the recording medium implement the functions of the embodiment and the recording medium storing the program codes constitutes the invention.

Examples of recording media that can be used for supplying the program code are a floppy (registered trademark) disk, hard disk, optical disk, magneto-optical disk, CD-ROM, CD-R, magnetic tape, non-volatile type memory card or ROM, etc.

Furthermore, besides the case where the aforesaid functions according to the embodiment are implemented by executing the program codes read by a computer, it goes without saying that the present invention covers a case where an operating system or the like running on the computer performs a part of or the entire process in accordance with the designation of program codes and implements the functions of the embodiment by this process.

It goes without saying that the present invention further covers a case where, after the program codes read from the storage medium are written in a memory provided on a function expansion board inserted into the computer or in a function expansion unit connected to the computer, a CPU or the like contained in the function expansion board or function expansion unit performs a part of or the entire process in accordance with the designation of program codes and implements the function of the above embodiment by this process.

In accordance with the present invention, judgment of coverage rate of properties which has been difficult in static verification can be performed objectively and exhaustive verification is possible. As a result, products having satisfactory accuracy can be introduced on the market.

Further, since it is possible to judge the reliability of a property objectively, a check of properties by human review performed heretofore is no longer required and it is possible to reduce verification labor and to improve the quality of properties. Further, since exhaustive verification in static verification becomes possible, verification can be divided into static verification and verification by dynamic simulation and verification labor can be reduced. Accordingly, development time can be shortened and products can be introduced on the market when they are desired.

As many apparently widely different embodiments of the present invention can be made without departing from the spirit and scope thereof, it is to be understood that the invention is not limited to the specific embodiments thereof except as defined in the appended claims.

This application claims the benefit of Japanese Application No. 2005-043143, filed Feb. 18, 2005, which is hereby incorporated by reference herein in its entirety.

What is claimed is:

1. A property generating method of generating a property for verifying a logic system, comprising:
a list generating step of generating a list of corresponding events from specifications that the logic system should meet; and
a property generating step of generating a second property that makes up for an event lacking in a first property.

2. The method according to claim 1, wherein the property generating step extracts the event lacking in the first property from the list of events and generates a property, which represents that the extracted event is improbable, as the second property.

3. The method according to claim 1, further comprising:
a step of implementing static verification of the logic system using the second property; and
an additional property generating step of generating a property, which is added to a property that has been created from the specifications, in accordance with result of implementation of the static verification.

4. The method according to claim 3, wherein the additional property generating step generates the second property as an additional property.

5. A verification method of verifying a logic system using a property, comprising:
a list generating step of generating a list of corresponding events from specifications that the logic system should meet;
a property generating step of generating a second property that makes up for an event lacking in a first property; and
a verification implementing step of implementing static verification of the logic system using the second property.

6. The method according to claim 5, wherein the property generating step extracts the event lacking in the first property from the list of events and generates a property, which represents that the extracted event is improbable, as the second property.

7. The method according to claim 5, further comprising an additional property generating step of generating a property, which is added to a property that has been created from the specifications, in accordance with result of implementation of the static verification.

8. A verification apparatus for verifying a logic system using a property, comprising:
property generating means for generating a list of corresponding events from specifications that the logic system should meet, and generating a second property that makes up for an event lacking in a first property; and
verification implementing means for implementing static verification of the logic system using the second property.

9. A program for causing a computer to execute the property generating method set forth in claim 1.

10. A program for causing a computer to execute the verification method set forth in claim 5.
